(19) United States
(12) Patent Application Publication
(10) Pub. No.: US 2019/0278196 A1
(43) Pub. Date: Sep. 12, 2019

(54) ELECTROCONDUCTIVE ROLLER

(71) Applicant: Hewlett-Packard Development Company, L.P., Houston, TX (US)

(72) Inventors: Bin Huang, San Diego, CA (US); Guang Jin Li, San Diego, CA (US)

(21) Appl. No.: 15/773,956

(22) PCT Filed: Jan. 27, 2016
(86) PCT No.: PCT/US2016/015109

§ 371 Date: May 4, 2018

(51) Int. Cl. G03G 15/08; G03G 15/10; G03G 15/056; G03G 9/08; C08L 67/04; C08L 75/04

(52) U.S. Cl. CPC G03G 15/0818; G03G 15/10; G03G 15/056; G03G 2215/0634; C08L 67/04; C08L 75/04; G03G 2215/0861; G03G 9/0806

(57) ABSTRACT

The present disclosure relates to an electroconductive roller for an electrophotographic printer. The roller comprises a polyurethane composition containing a polyurethane and an ionic liquid. The cation of the ionic liquid is an organic cation. The polyurethane composition has a specific resistivity of 1×10⁵ Ω·cm to 1×10⁸ Ω·cm.

### BACKGROUND

An electrophotographic printing process involves creating an image on a photoconductive surface or photo imaging plate (PIP). The image that is formed on the photoconductive surface is a latent electrostatic image having image and background areas with different potentials. When an electrophotographic ink composition containing charged ink particles is brought into contact with the selectively charged photoconductive surface, the charged ink particles adhere to the image areas of the latent image while the background areas remain clean. The image is then transferred to a print substrate (e.g. paper) either directly or by first being transferred to an intermediate transfer member (e.g. a soft swelling blanket) and then to the print substrate.

### BRIEF DESCRIPTION OF THE DRAWINGS

Various implementations are described, by way of example, with reference to the accompanying drawings, in which:

FIG. 1 is a cross-sectional diagram of a binary image development unit according to one example of the ink developer unit described in this disclosure;

FIG. 2 is a graph showing how the specific resistivities of polyurethane compositions produced in Example 1 vary with increasing concentrations of ionic compound at varying humidity levels (see Example 2);

FIG. 3 is a bar chart showing how the specific resistivities of polyurethane compositions of Example 3 vary with humidity (see Example 4);

FIG. 4 is a graph showing how the resistance of rollers formed using the polyurethane compositions of Example 3 vary with humidity (see Example 5); and

FIG. 5 is a graph showing how the resistance of the samples prepared in Example 5 varies when subjected to an electric field over different periods of time.

### DETAILED DESCRIPTION

Before the present disclosure is described, it is to be understood that this disclosure is not limited to the particular process steps and materials disclosed in this description because such process steps and materials may vary. It is also to be understood that the terminology used in this disclosure is used for the purpose of describing particular examples. The terms are not intended to be limiting because the scope is intended to be limited by the appended claims and equivalents.

It is noted that, as used in this specification and the appended claims, the singular forms “a,” “an,” and “the” include plural referents unless the context clearly dictates otherwise.

As used in this disclosure, “electrostatic printing” or “electrophotographic printing” refers to the process that provides an image that is transferred from a photoconductive surface or photo imaging plate either directly or indirectly via an intermediate transfer member to a print substrate. As such, the image may not be substantially absorbed into the photo imaging substrate on which it is applied. Additionally, “electrophotographic printers” or “electrostatic printers” refer to those printers capable of performing electrophotographic printing or electrostatic printing, as described above. An electrophotographic printing process may involve subjecting the electrophotographic composition to an electric field, e.g. an electric field having a field gradient of 1-400 V/μm, or more, in some examples 600-900 V/μm, or more.

As used in this disclosure, the term “about” is used to provide flexibility to a numerical value or range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description in this disclosure.

As used in this disclosure, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5. This same principle applies to ranges reciting a single numerical value. Furthermore, such an interpretation should apply regardless of the breadth of the range or the characteristics being described.

In the present disclosure, the term “isocyanate” is meant to be broadly understood as a functional group of atoms composed of units of the form —N═C═O (1 nitrogen, 1 carbon, 1 oxygen).

The present disclosure relates to an electroconductive roller for an electrophotographic printer. The roller comprises a polyurethane composition containing a polyurethane and an ionic liquid. The cation of the ionic liquid is an organic cation. The polyurethane composition has a specific resistivity of 1×10⁵ Ω·cm to 1×10⁸ Ω·cm.

The present disclosure also relates to a liquid electrophotographic printer that comprises an electroconductive roller. The electroconductive roller comprises a polyurethane composition containing polyurethane and an ionic liquid. The cation of the ionic liquid is an organic cation. The polyurethane composition has a specific resistivity of 1×10⁵ Ω·cm to 1×10⁸ Ω·cm.

The present disclosure also relates to a method of developing an ink. The method comprises using an electric field to apply a liquid electrophotographic ink comprising an organic solvent to a surface of a developer roller; removing organic solvent from a surface of a developer roller using a secondary roller, and transferring the remaining electrophotographic ink from the surface of the developer roller to a photo-imaging plate to create an image. The developer roller comprises a polyurethane composition containing a polyurethane and an ionic liquid. The cation of the ionic liquid is an organic cation and the polyurethane composition has a specific resistivity of 1×10⁵ Ω·cm to 1×10⁸ Ω·cm.

An electroconductive roller may be used as a developer roller in a liquid electrophotographic printer to develop and transport a uniform layer of ink onto a photoconductive surface. The developer roller is conductive and has a specific resistivity sufficient to retain and dissipate charge as required to develop the ink. Developer rollers may be formed of elastomeric polymers, for example, polyurethane to provide them with the mechanical properties required to co-operate with other rollers and surfaces in the printer, for example, the photo-imaging plate.

A developer roller having a desired specific resistivity may be produced by doping a polymer roller (e.g. polyurethane) with an alkali metal salt, for example, a lithium salt. The conductivity provided by lithium salts, however, may vary significantly depending on environmental factors, for example, humidity. This may cause fluctuations in the quality of the image produced by the printer. Moreover, over time, the lithium salt may leach out of the roller, reducing its conductivity. The lithium salt may cause parts (e.g. metal parts) of the printer to corrode. Furthermore, leached lithium ions may contact the photo-imaging plate, causing the photo-imaging plate to become conductive. If the latter occurs, it may become difficult to appropriately charge the photo-imaging plate, leading to a poorly formed latent image. This, in turn, may affect the overall quality of the final print.

It has been found that an ionic liquid containing an organic cation can be used to control the specific resistivity of a polyurethane composition within the range of 1×10⁵ to 1×10⁸ Ω·cm (e.g. 5×10⁵ to 1×10⁷ Ω·cm), such that an electroconductive roller can be produced whose conductivity can be maintained over a sustained period of time. Furthermore, the conductivity of the roller may be less susceptible to change caused by fluctuations in environmental factors, such as changes in the surrounding humidity. Without wishing to be bound by any theory, the organic cations of the ionic liquid have been found to be less prone migration from the polyurethane. As a result, they are less likely to leach out of the polyurethane composition. Furthermore, the organic cations do not interact with moisture in the same way as lithium ions. Accordingly, the conductivity of the resulting polyurethane composition may be less affected by changes in, for example, the surrounding humidity.

### Ionic Liquid

Any suitable ionic liquid may be used to form the electroconductive roller of the present disclosure. The ionic liquid may be in a liquid state at a temperature of 50 degrees C. or less, for example, 40 degrees or less. In one example, the ionic liquid may be in a liquid state at a temperature of 30 degrees or less, for instance, 25 degrees or less.

The ionic liquid comprises an organic cation. In some examples, the organic cation has a positively charged nitrogen atom. The organic cation may have an average molecular weight, Mw, of 50 to 1000, for example, 100 to 500.

The organic cation may be selected from an imidazolium cation, a piperidinium cation, a pyridinium and a quaternary ammonium cation. In one example, the organic cation may be an imidazolium cation or a quaternary ammonium cation. The quaternary ammonium cation may be of the formula NR₁R₂R₃R₄⁺, wherein each of R₁, R₂, R₃ and R₄ is independently selected from a (e.g. substituted or unsubstituted) hydrocarbyl group. Examples of suitable hydrocarbyl groups include an alkyl, cycloalkyl or aryl group. In one example, the ionic cation is selected from an imidazolium cation and a quaternary ammonium cation, for instance, of the formula NR₁R₂R₃R₄⁺, wherein each of R₁, R₂, R₃ and R₄ is independently selected from a substituted or unsubstituted hydrocarbyl group, for example, an alkyl, cycloalkyl or aryl group.

Where the cation is quaternary ammonium cation of the formula NR₁R₂R₃R₄⁺, each R group may be a substituted or unsubstituted hydrocarbyl groups, for example, containing 1 to 20 carbon atoms, for example, 1 to 12 carbon atoms. Where substituted, the hydrocarbyl group may be substituted with a hetero-atom containing functional group, for example, an O-, S- or N-containing functional group. Examples of suitable functional groups include ether, thioether and amine functional groups.

The hydrocarbyl group may be an alkyl group. Suitable alkyl groups include straight chain or branched alkyl groups. The alkyl group may have 1 to 20 carbon atoms, for example, 1 to 12 carbon atoms. In some examples, the alkyl group has 1 to 10 carbon atoms. Examples of suitable alkyl substituents include methyl, ethyl, propyl (e.g. iso- or n-propyl), butyl (e.g. n-, sec- or t-butyl), pentyl, hexyl, heptyl, octyl, nonyl or decyl.

The hydrocarbyl group may be a cycloalkyl group. Suitable cycloalkyl groups may have rings formed of 3 to 12 carbon atoms, for example, 5 or 6 carbon atoms. Examples include pantyl and hexyl.

The hydrocarbyl group may be an aryl group. Suitable aryl groups include aryl groups formed of 5-or 6-membered rings. An example is a phenyl group.

Examples of suitable ammonium cations include N,N,N,N-tetrabutylammonium, N,N,N,N-tetrapentyl-ammonium, N,N,N,N-tetra-hexylammonium, N,N,N,N-tetraheptylammonium, N,N,N,N-tetraoctylammonium, N,N,N,N-tetranonylammonium, N,N,N,N-tetradecylammonium, N,N,N,N-tetradodecylammonium, N,N,N,N-tetrahexadecyl-ammonium, and N,N,N,N-tetraoctadecylammonium. Further examples include N,N,N-trimethyl-N-propylammonium, N,N,N-trimethyl-N-butylammonium, N,N,N-trimethyl-N-pentylammonium, N,N,N-trimethyl-N-hexylammonium, N,N,N-trimethyl-N-heptylammonium, N,N,N-trimethyl-N-octylammonium, N,N,N-trimethyl-N-nonylammonium, and N,N,N-trimethyl-N-decylammonium.

Where the cation is an imidazolium cation, both nitrogen atoms of the imidazolium ion may be substituted with a (e.g. substituted or unsubstituted) hydrocarbyl group. Where substituted, the hydrocarbyl group may be substituted with a hetero-atom containing functional group, for example, an O-, S- or N-containing functional group. Examples of suitable functional groups include ether, thioether and amine functional groups.

The hydrocarbyl group may be an alkyl group. Suitable alkyl groups include straight chain or branched alkyl groups. The alkyl group may have 1 to 20 carbon atoms, for example, 1 to 12 carbon atoms. In some examples, the alkyl group has 1 to 10 carbon atoms. Examples of suitable alkyl substituents include methyl, ethyl, propyl (e.g. iso- or n-propyl), butyl (e.g. n-, sec- or t-butyl), pentyl, hexyl, heptyl, octyl, nonyl or decyl.

The hydrocarbyl group may be a cycloalkyl group. Suitable cycloalkyl groups may contain rings formed of 3 to 12 carbon atoms, for example, 5 or 6 carbon atoms. Examples include pentyl and hexyl.

The hydrocarbyl group may be an aryl group. Suitable aryl groups include aryl groups containing of 5-or 6-membered rings. An example is a phenyl group.

Examples of suitable imidazolium cations include 1-ethyl-3-methyl imidazolium (EMI), 1-hexyl-3-methylimidazolium (HMI), 1-decyl-3-methylimidazolium (DMI), and 1-butyl-3-methylimidazolium (BMI).

In one example, the cation is selected from tributylmethyl ammonium (TBMA), trimethylbutyl ammonium (BTMA), 1-ethyl-3-methyl imidazolium (EMI), 1-hexyl-3-methylimidazolium (HMI), 1-decyl-3-methylimidazolium (DMI), 1-butyl-3-methylimidazolium (BMI), 1-butyl-3-methylpyridinium (BMPy) and cyclohexyltrimethyl ammonium (CHTMA). In another example, the cation is selected from from tributylmethyl ammonium (TBMA), 1-ethyl-3-methyl imidazolium (EMI) and 1-hexyl-3-methylimidazolium (HMI).

Any suitable anion may be present in the ionic liquid. Suitable examples include halogen ions, BF₄⁻, PF₆⁻, CF₃SO₃⁻ (trifluoromethanesulfonyl ion), and (CF₃SO₂)₂N⁻ (bis(trifluoromethanesulfonyl)imide ion or TFSI). In one example, the anion is bis(trifluoromethanesulfonyl)imide ion (TFSI).

The ionic liquid may be present at a concentration of 0.5 to 20 weight % of the polyurethane composition. For example, the ionic liquid may be present at a concentration of 0.5 to 10 weight %, for instance, 1 to 5 weight % of the polyurethane composition. In one example, the amount of ionic liquid employed is controlled to provide the polyurethane composition with a specific resistivity of 1×10⁵ to 1×10⁸ Ω·cm or 1×10⁶ to 1×10⁷ Ω·cm. In one example, the amount of ionic liquid employed is controlled to provide the polyurethane composition with a specific resistivity of 5×10⁵ to 1×10⁷ Ω·cm. In one example, the amount of ionic liquid employed is controlled to provide the polyurethane composition with a specific resistivity of 1×10⁶ to 5×10⁶ Ω·cm. In one example, the amount of ionic liquid is less than 10 weight %, for example, less than 5 weight % of the total weight of the polyurethane composition. The amount of ionic liquid may be controlled to provide the polyurethane composition with the target conductivity, without overly compromising the mechanical properties of the roller. In one example, the ionic liquid is present in an amount of 1 to 3 weight %, for instance, 1 to 2 weight % of the polyurethane composition.

### Polyurethane

Any suitable polyurethane may be used in the polyurethane composition. For example, the polyurethane may be a reaction product of a polyol and an isocyanate compound, for example, a diisocyanate or polyisocyanate. Suitable polyols include polyester and polyether polyols.

In one example, the polyol may be a polyol containing a polyether functional group or a polycaprolactone polyol. Such polyols may be used to form polyurethanes that may interact with the organic cations of the ionic liquid, such that the conductivity of the resulting polyurethane composition is enhanced beyond that which would be expected on the basis of the conductivity of the ionic liquid alone. Without wishing to be bound by any theory, it is believed that the ether or caprolactone functionality may interact with the organic cation to enhance conductivity.

Where a polyether functional group is employed, the polyol may be ethoxylated, whereby it contains a functional group having at least 2 carbon atoms between oxygen atoms. The moiety may be derived from at least one of ethylene glycol, di(ethylene glycol), tri(ethylene glycol), tetra(ethylene glycol), poly(diethylene glycol), poly(ethylene oxide) or mixtures thereof. The moiety may be present in the polyol chain or at the terminus. The moiety may contain a (—CH₂CH₂O—) group or a (—CH₂CH₂O—)ₙ group, where in an integer of 2, 3, 4 or more. For example, n may be 1 to 30, for instance, 1 to 10.

In one example, the moiety is present in an amount of at least about 10 mol % of the polyol. In another embodiment, the moiety is present in an amount of 20 mol % to 50 mol % of polyol.

The polyol may also have a low glass transition temperature (“T_{g}”) of, for example, less than about 0° C.

The polyol may be a polyester polyol or a polyether polyol. The polyol may be synthesized by techniques including a condensation reaction of a diol with a dicarboxylic acid. The diol may include, but is not limited to, a glycol. For instance, a polyalkylene glycol, such as DEG, TEG, tetraethylene glycol, or mixtures thereof may be used. The dicarboxylic acid may include adipic acid (“AA”), maionic acid, glutaric acid, pimelic acid, azelaic acid, sebacic acid, suberic acid, brassylic acid, succinic acid, decanedicarboxylic acid, dodecanedicarboxylic acid, 1,3-cyclohexanedicarboxylic acid, 1,4-cyclohexanedicarboxylic acid, phthalic acid, terephthalic acid, isophthalic add, and mixtures thereof. In one example, the polyester polyol includes AA and DEG and has the following structure:

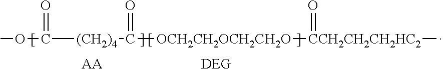

In another example, the polyester polyol includes AA and TEG. It is understood that other dicarboxylic acids, besides AA, may be used in the polyester polyol. Examples of polyether polyols include, but are not limited to, poly(ethylene glycol), poly(propylene glycol), and poly(tetramethylene glycol).

Suitable polyols include polyester polyols containing polyether groups, for example, as sold under the trademark Desmophene F207-60A (Coverstro®). Other examples include polycaprolactone polyols, for example, sold under the trademark Capa 2010A (Perstorp®).

As mentioned above, isocyanate compounds may be used to react with the polyol to produce the polyurethane. Isocyanate compounds may include, but are not limited to, a diisocyanate, such as tolulenediisocyanate, diphenylmethanediisocyanate, xylylenediisocyanate, naphthylenediisocyanate, paraphenylenediisocyanate, tetramethylxylenediisocyanate, hexamethylenediisocyanate, 4,4-dicyclohexylmethanediisocyanate, isophoronediisocyanate, or tolidinediisocyanate. In one example, aromatic isocyanate compound is employed, for instance, diphenylmethane-diisocyanate (MDI). In one example, polymeric isocyanate compounds are used, for example, polymeric isocyanates formed from diphenylmethane-diisocyanate (MDI). The isocyante may also contain polyether/ethoxylate functional moieties. For example, the isocyante may also contain polyether/ethoxylate functional moieties, such as the polyols described herein.

In some examples, a catalyst is used to catalyse the reaction between the polyol and isocyanate compound. An example of a suitable catalyst is 1,4-diazabicyclo [2.2.2] octane solution (e.g. Dabco 33-LV supplied by Air Products and Chemicals, Inc.).

### Polyurethane Composition

The polyurethane composition has a specific resistivity of 1×10⁵ Ω·cm to 1×10⁶ Ω·cm, for example, 5×10⁵ Ω·cm or 1×10⁶ Ω·cm to 1×10⁷ Ω·cm. In one example, the polyurethane composition has a specific resistivity of 3×10⁶ to 5×10⁶ Ω·cm. Specific resistivity is an intrinsic property that quantifies how strongly a given material opposes the flow of electric current. It may be defined as ρ=R(A/I), where ρ is the specific resistivity, R is the electrical resistance of the specimen, A is the contact area and I is the length or depth of the specimen. Specific resistivity may be measured according to ASTM D257. Alternatively, it may be determined from a disc formed of a given polyurethane sample having a known thickness (e.g. 2 mm). The disc may be sandwiched between 2 electrodes of a known size (e.g. 30 mm diameter). A known voltage (e.g. 100V DC) may be applied across the electrodes (e.g. for 1 second at 20 degrees C.) and the resistance measured. Specific resistivity may be calculated from the resistance measurement using the electrode contact area and disc thickness. The specific resistivity may be measured once the polyurethane composition has been conditioned at 50% relative humidity at 20 degrees C. for 5 or more days, for example, 5 to 10 or 15 days. In one example, the specific resistivity may be measured once the polyurethane composition has been conditioned at 50% relative humidity at 20 degrees C. for 5 days.

The polyurethane composition may have a Shore A hardness of 20-70, for example, 30-50. The Shore A durometer may be measured according to ASTM Method D2240-86.

The polyurethane composition may be sufficiently resilient to co-operate with other rollers in the electrophotographic printer, for example, the photo-conductive plate, squeegee roller and/or cleaner roller.

The polyurethane composition may exhibit a compression set B, as measured by ASTM 395 method B (at a compression of 25% at a temperature of 100° C. for 70 hours), in the range of <50% of the original deflection. The sample is allowed to recover at room temperature for 30 min for final thickness measurement.

The polyurethane composition may be formed by adding the ionic liquid to either or both of the polyol (or polyol precursor) and isocyanate compound (e.g. diisocyanate compound). When the polyol reacts with the isocyanate to form a polyurethane, the ionic compound may be incorporated in situ into the resulting polyurethane composition.

The polyurethane composition may contain less than 5 weight % lithium salt, for example, less than 2 weight % lithium salt. In one example, the polyurethane composition contains less than 1 weight % lithium salt, for instance, less than 0.5 weight % lithium salt. In another example, the polyurethane composition is substantially devoid of lithium salt.

The polyurethane composition may include further additives. Examples of such additives antioxidants (e.g. carbodiimide), anti-foaming agents, flame retardants, cure accelerators, thickeners, light stabilizers, wetting agents and mould-release agents. The total amount of additives present may be up to 5 weight %, for example, 0.01 to 5 weight %.

### Electroconductive Roller

The electroconductive roller may be a developer roller in an electrophotographic printer, for example, a liquid electrophotographic printer. The developer roller may comprise an inner core (or central shaft) and an outer layer. The inner core may be made of metal or other conductive material. The inner core may be rigid enough to support the outer layer as well as interact with secondary roller(s) within the ink developer unit. In one example, the inner core takes the form of a cylindrical rod. Where a metal or conductive material is used to form the inner, the metal or conductive material may be sufficiently conductive to allow charge to transfer from the inner core and into the outer layer.

The outer layer may be formed of polyurethane as described in this disclosure. The polyurethane composition may be in direct contact with the inner core. The polyurethane composition may be cast, coated or moulded onto the inner core, for example, a metal core to form the roller. The polyurethane of the outer layer may have a thickness of at least 1 mm, for example, 1 to 10 mm.

### Liquid Electrophotographic Printer

As described above, the present disclosure also relates to a liquid electrophotographic printer comprising an electroconductive roller comprising a polyurethane composition containing the polyurethane and ionic liquid. The electroconductive roller may be a developer roller. The printer may also comprise a secondary roller, for example, a squeegee roller that co-operates with the developer roller to remove excess liquid (e.g. organic solvent) from the surface of the developer roller.

The squeegee roller may be more charged (positively or negatively, depending on charge of ink particles) relative to the developer roller and may abut the developer roller creating a nip. In use, as the squeegee roller comes in contact with the developer roller, the ink layer on the developer roller may be more concentrated. In one example, the squeegee roller may help to develop the ink layer and remove enough solvent from the ink such that the particle concentration is increased.

The printer may additionally comprise a further secondary roller, for instance, a cleaner roller. A cleaner roller may be used to remove excess ink from the developer roller after a proportion of the ink has been transferred to the photo-imaging plate. The cleaner roller may have a more positive or negative bias (depending on charge of ink particles) compared to the developer roller. As such, the charged ink particles may be attracted to the cleaner roller and thereby removed from the developer roller.

The squeegee roller and/or cleaner roller may be formed of metal.

The developer roller may be at a different bias against the electrodes or secondary roller(s). The difference may be 100 to 1200V. The nip resistance between the developer roller or any secondary roller may be 0.03-30 kOhm/cm of roller length, for example, 0.6-15 kOhm/cm of roller length. The secondary roller may be formed of metal.

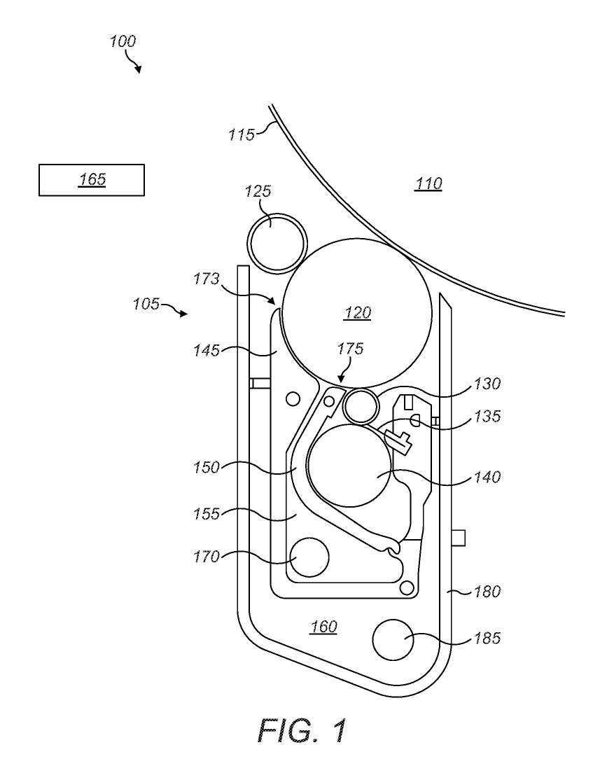

### Description of FIG. 1

By way of example, FIG. 1 is a cross-sectional diagram of an ink development unit. In this example, the ink development unit is a binary image development unit (105). The binary image development unit (105) comprises a developer roller (120). The developer roller may be formed of an inner metal rod surrounded by a polyurethane composition according to one example of the present disclosure (not shown). The binary image development unit (105) may also comprise a number of other static parts and rollers which cooperate with the developer roller (120) to transport an amount of ink from the binary image development unit (105) to the photo imaging plate (115) on the photo imaging drum (110). A binary image development unit (105) as shown in FIG. 1 may be included within a liquid electrophotographic printing system (100). The liquid electrophotographic printing system (100) may include any number of binary image development units (105) as needed, each unit (105) containing a different colour or type of ink with which to apply to the photo imaging plate (115). An example of such a system (100) can be found within some of the INDIGO® digital presses manufactured by Hewlett-Packard Company. Additionally, an example of an ink that may be used within the binary image development unit (15) may be an ink containing charged pigmented particles in a liquid carrier developed and manufactured by Hewlett-Packard Company under the trademark Electroink®.

In addition to the developer roller (120), the binary image development unit (105) may include a back electrode (150), a main electrode (145), a squeegee roller (125), a cleaner roller (130), a wiper blade (135), a sponge roller (140), an ink chamber (155), an ink reservoir (160), an ink inlet (170), and an ink outlet. The liquid electrophotographic printing system (100) therefore may include the binary image development unit (105) as well as a photo imaging plate (115) coupled to a photo imaging drum (110) and an imager (165). Each of these will now be discussed in more detail.

The binary image development unit (105) selectively coats the photo imaging plate (115) with an amount of ink. To accomplish this, separate ink tanks may be used to hold and control the desired properties of the ink such the ink's density and conductivity. One ink tank may be used for each colour. In an idle stage, for example, before printing starts, the binary image development unit (105) may be empty (i.e. devoid of ink). To start developing ink, the binary image development unit (105) may be provided with a flow of ink pumped from ink tanks (not shown) through the ink inlet (170) that allows a continuous supply of ink at the development area, i.e., the gaps (173,175) between developer roller (120) and electrodes (150, 145). As mentioned earlier, the ink may be positively or negatively charged. For purposes of simplicity in illustration, the ink within the binary image development unit (105) in FIG. 1 is described as if it is negatively charged. Still further the ink may contain varying amounts of solids within the ink solution. In one example, the ink may be comprised of 2-3% solids.

As the ink is pumped into the ink chamber (155) via the ink inlet (170), two electrodes, a main electrode (145) and a back electrode (150), apply an electric field across two gaps (173, 175). A first gap (173) is located between the main electrode (145) and the developer roller (120), and a second gap (175) is located between the back electrode (150) and the developer roller (120). The electric charge across these gaps (173, 175) causes the ink particles to be attracted to the more positively charged developer roller (120).

The developer roller (120) may be made of a polyurethane material with an amount of conductive filler, for example, carbon black mixed into the material. As discussed above, this may give the developer roller (120) the ability to hold a specific charge having a higher or lower negative charge compared to the other rollers (125, 110, 130) with which the developer roller (120) directly interacts.

In one example, the electrical bias between the electrodes (145, 150) and the developer roller (120) produces an electric field between the electrodes (145, 150) and the developer roller that is about 800-1000 volts. With a gap (173, 175) of about 400-500 μm, the electric field becomes relatively high and the negatively charged ink particles are attracted to the developer roller (120). This creates a layer of ink over the developer roller (120).

As the ink particles are built up on the developer roller (120), a squeegee roller (125) is used to squeeze the top layer of oil away from the ink. The squeegee roller (125) also develops some of the ink onto the developer roller (120). In order to accomplish these two objectives, the squeegee roller (125) may be both more negatively charged relative to the developer roller (120) and may abut the developer roller (120) creating a nip. As the squeegee roller (125) comes in contact with the developer roller (120), the ink layer on the developer roller (120) may now be more concentrated. In one example, the squeegee roller (125) may develop the ink layer and remove enough oil (or organic solvent) from the ink such that the particle concentration is increased. In one example, the resulting ink concentration may be around 20% to 25% colorant concentration.

After the ink on the developer roller (120) has been further developed and concentrated by the squeegee roller (125), the ink may be transferred to the photoconductive photo imaging plate (115). In one example, the photo imaging plate (115) may be coupled to a photo imaging drum (110). In another example, the photo imaging drum (110) may incorporate the photo imaging plate (115) such that the photo imaging drum (110) and photo imaging plate (115) are a single piece of photoconductive material. However, for the purposes of simplicity in illustration, the photo imaging plate (115) and photo imaging drum (110) are separate pieces thereby allowing the photo imaging plate to be selectively removed from the photo imaging drum (110) for replacement if needed.

In one example, prior to transfer of ink from the developer roller (120) to the photo imaging plate (115), the photo imaging plate or, alternatively, the photo imaging drum (110) and plate (115), may be negatively charged with a charge roller. A latent image may, therefore, be developed on the photo imaging plate (115) by selectively discharging selected portions of the photo imaging plate (115) with, for example, a laser (165). The discharged area on photo imaging plate (115) may now be more positive as compared with developer roller (120), while the charged area of photo imaging plate (115) may still relatively be more negative as compared with developer roller (120). When the developer roller (120) comes in contact with the photo imaging plate (120) the negatively charged ink particles are attracted to the discharged areas on the photo imaging plate (115) while being repelled from the still negatively charged portions thereon. This creates an image on the photo imaging plate (115) which will then be transferred to another intermediate drum or directly to a sheet of media such as a piece of paper.

Because a portion of the ink is transferred from the developer roller (120) to the photo imaging plate (115), the excess ink may be removed from the developer roller (120) using a cleaner roller (130). The cleaner roller (130) may have a more positive bias compared to the developer roller (120). As such, the negatively charged ink particles are attracted to the cleaner roller (130) and thereby removed from the developer roller (120). A wiper blade (135) and sponge roller (140) may subsequently remove the ink from the cleaner roller (130).

The developer roller (120) may be compliant with the other rollers with which it interacts; namely the squeegee roller (125), the cleaner roller (130), and the photo imaging plate (115) and drum (110). These rollers (125, 130) and the photo imaging plate (115) are made of hard materials such as metal. Therefore, the developer roller (120) may be made of a material that has a low hardness value compared to these other rollers (125, 130), the photo imaging plate (115), and the photo imaging drum (110).

### EXAMPLE 1

Polyurethane compositions A were prepared from a diethylene glycol-containing polyester polyol with varying amounts of the following ionic compounds: lithium bis(trifluoromethane)sulfonimide (LiTFSI) and tributylmethylamine bis(trifluoromethane)sulfonimide (TBMA). The polyurethane compositions were formed from the components and amounts shown in the table A below.

A. Polyurethane Compositions Formed from DEG-Containing Polyester Polyol

| Material | Weight (g) |
|---|---|
| Polymeric isocyanates based on diphenyl | 16.83 |
| methane diisocyanate (Mondur ® MR light | |
| supplied by Covestroe) | |
| DEG-containing polyester polyol | 100 |
| (Desmophene ® F207-60 supplied by | |
| Covestro ® | |
| 1, 4 Diazabicyclo [2.2.2] octane solution | 0.02 |
| (catalyst) | |
| Ionic Compound (i.e. Lithium | Varies (3.48, 10.45, 20.9, 34.8 |
| bis(trifluoromethane)sulfonimide (LiTFSI) | mmol per 100 g of resin (phr)) |
| or Tributylmethylamine | |
| bis(trifluoromethane)sulfonimide (TBMA | |
| TFSI)) | |

A mixture of the polyol and ionic compound was heated to 70 degrees C. and degassed under vacuum with mixing. Catalyst was then added as solution. Diisocyanate degassed at room temperature under vacuum was added to the formulation immediately prior to moulding. The formulation was cast into a mould for 2 mm-thick sheet and cured at cured at 120° C. for 3 hours. The samples were then demoulded and conditioned at 20 degrees C. at specified RH % for at least 7 days before measurement.

The above method was repeated to produce polyurethane compositions B and C from the materials and amounts shown in the tables below.

B. Polyurethane Compositions Formed from Polycaprolactone Polyol

| Material | Weight (g) |
|---|---|
| Polymeric isocyanates based on diphenyl | 31.68 |
| methane diisocyanate (Mondur ® MR light | |
| supplied by Covestro ®) | |
| Polycaprolactone polyol, Cape ® 2010A | 100 |
| (supplied by Perstorpe) | |
| 1, 4 Diazabicyclo [2.2.2] octane solution | 0.02 |
| (catalyst) | |
| Ionic Compound (i.e. Lithium | Varies (3.48, 10.45, 20.9, 34.8 |
| bis(trifluoromethane)sulfonimide (LiTFSI) | mmol per 100 g of resin (phr)) |
| or Tributylmethylamine | |
| bis(trifluoromethane)sulfonimide (TBMA | |
| TFSI)) | |

C. Polyurethane Composition Formed from Polycarbonate Polyol

| Material | Weight (g) |
|---|---|
| Polymeric isocyanates based on diphenyl | 15.84 |
| methane diisocyanate (Mondur ® MR light | |
| supplied by Covestro ®) | |
| Desmophene ® C2200 supplied by | 100 |
| Cavestro ® | |
| 1, 4 Diazabicyclo [2.2.2] octane solution | 0.02 |
| (catalyst) | |
| Ionic Compound (i.e. Lithium | Varies (3.48, 10.45, 20.9, 34.8 |
| bis(trifluoromethane)sulfonimide (LiTFSI) | mmol per 100 g of resin (phr)) |
| or Tributylmethylamine | |
| bis(trifluoromethane)sulfonimide (TBMA | |
| TFSI)) | |

### EXAMPLE 2

After curing, the specific resistivities of polyurethane compositions formed from DEG-containing polyester polyol (see A above) were conditioned in environmental chambers set at 20C but different RH %, e.g. 20%, 50%, 80% for at least 7 days before resistivity measurement was taken.

Specific resistivity was determined by forming a 2 mm-thick disc of the relevant polyurethane. The disc was sandwiched between 2 electrodes of 30 mm diameter. A voltage of 100V DC was applied across the electrodes and the resistance measured after 1 second of electrification. Specific resistivity was calculated from the resistance measurement using the electrode contact area and disc thickness.

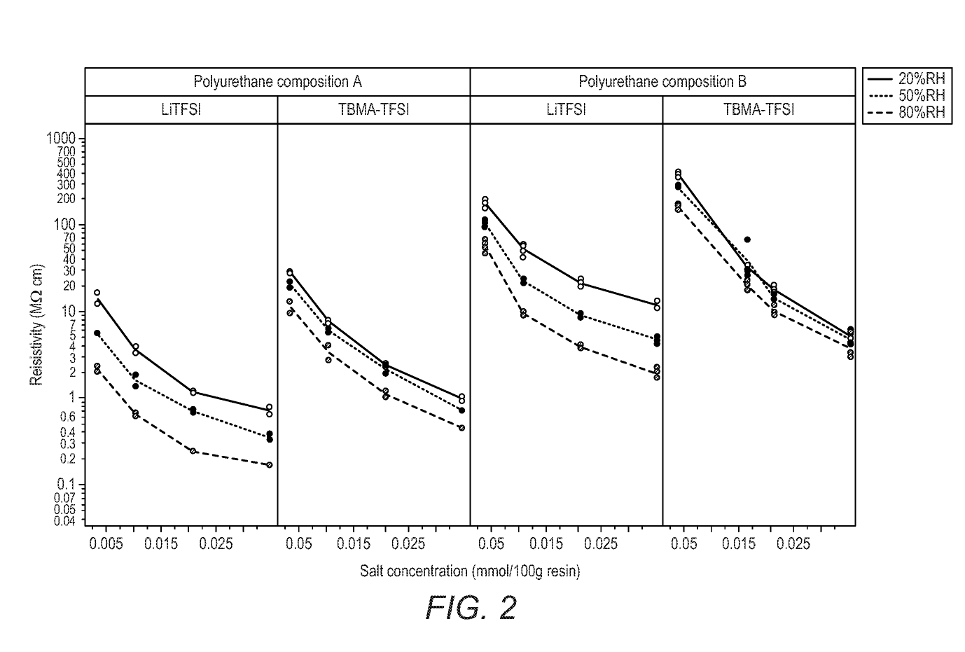

FIG. 2 plots the specific resistivities of the compositions A against increasing concentrations of ionic compound at relative humidity levels of 20%, 50% and 80%, respectively. It can be seen that, for TBMA TFSI, resistivity was less susceptible to change with changes in humidity.

The specific resistivities of polyurethane compositions formed from polycaprolactone polyols (see B) were determined at relative humidity levels of 20%, 50% and 80% using the above procedure.

FIG. 2 also shows the resistivities of these compositions against increasing concentrations of ionic compound at relative humidity levels of 20%, 50% and 80%, respectively. It can be seen that, with TBMA TFSI as the ionic compound, resistivities were less susceptible to change with changes in humidity.

The specific resistivities of polyurethane compositions formed from polycarbonate polyols were also found to be less susceptible to changes in humidity when TBMA TFSI was used as the ionic compound. However, a large concentration of TBMA TFSI was required to achieve the target resistivity values compared to the concentrations required for polyurethane compositions A and B. This was believed to be because of the nature of the polyol (polycarbonate polyol) used to prepare the polyurethane compositions in C.

### EXAMPLE 3

Polyurethane compositions D were prepared using the components and amounts shown in the table below.

| Material | Amount |
|---|---|
| Polymeric isocyanates based on diphenyl | 10.8 g |
| methane diisocyanate (Mondur ® MR light | |
| supplied by Covestro ®) | |
| DEG-containing polyester polyol | 100 g |
| (Desmophene ® 207-60 supplied by | |
| Cavestro ® | |
| 1, 4 Diazabicyclo [2.2.2] octane solution | 0.02 g |
| (catalyst) | |
| BYK LPX 5795 (mould-release agent) | 0.15 |
| Stabaxol P200 (antioxidant from Rhein | 1.5 |
| Chemie) | |
| Ionic Compound (i.e. Lithium | Varies (2.44 and 4.88 mmol |
| bis(trifluoromethane)sulfonimide (LiTFSI); | per 100 g of resin (phr)) |
| 1-ethyl-3-methyl imidazolium (EMI) or | |
| Tributylmethylamine | |
| bis(trifluoromethane)sulfonimide (TBMA | |
| TFSI)) | |

### EXAMPLE 4

The specific resistivities of polyurethane compositions D were determined at relative humidity levels of 20% and 80% using the procedure described above in relation to Example 2 above.

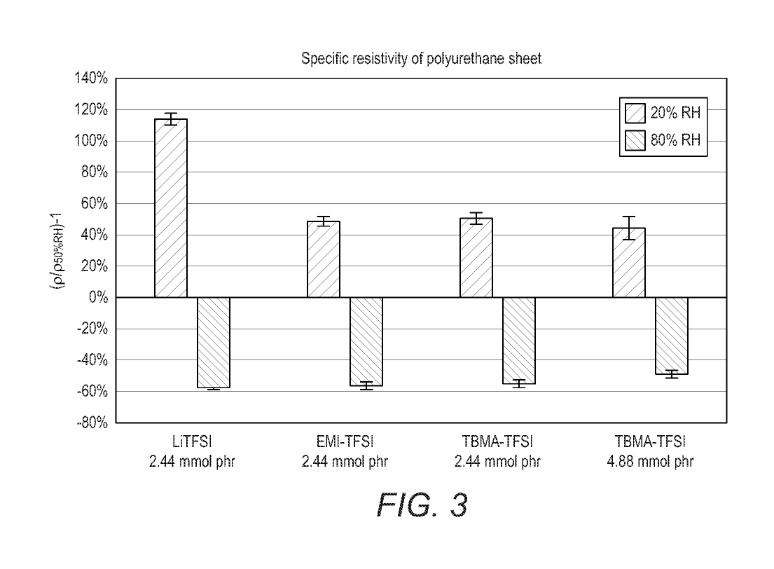

The results are shown in FIG. 3. As can be seen from the bar chart, the specific resistivity was less affected with changes in humidity with the ionic liquids.

### EXAMPLE 5

The polyurethane compositions of Example 3 above were cast into a mould for rollers with roller shaft pre-installed and cured at 120° C. for 3 hours. The roller were then demoulded and conditioned at 20 degrees C. at specified RH % for at least 7 days before measurement.

The resistance was measured using a dynamic roller resistance tool. The roller under test was rotated between 3 metal rollers. Power supply provided at about 100 DC volts to the shaft of one of the metal rollers with the ground return going through the shaft of the roller being tested. During operation, the current flowing through the polyurethane layer of the roller and the effective resistance of the polyurethane layer was calculated using Ohm's law, r=V/I.

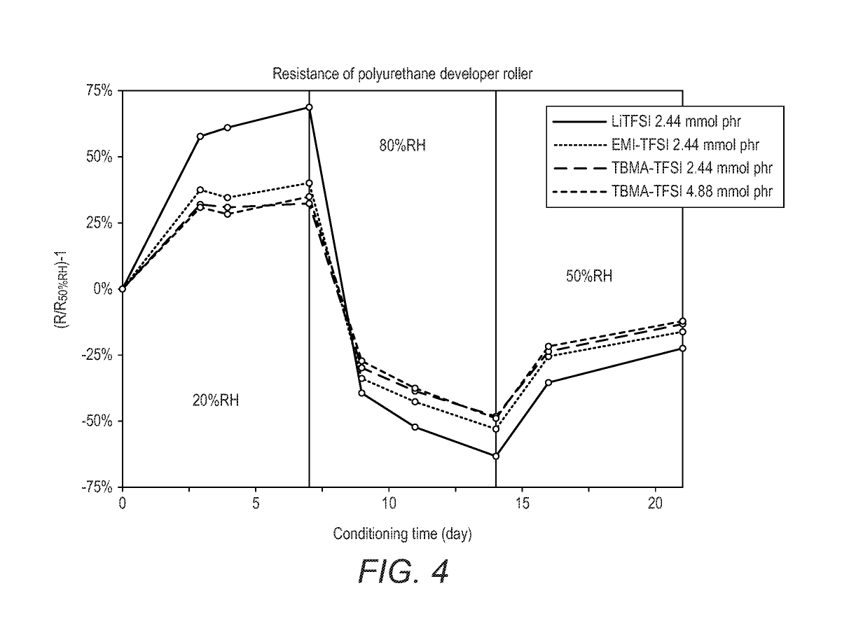

The results are shown in FIG. 4. It can be seen that the resistance is less susceptible to variation when the ionic liquids are employed compared to when a lithium salt is employed.

### EXAMPLE 6

In this Example the properties of the rollers tested in Example 4 were tested for their electrical and printing properties. The electrical properties of the rollers are shown in the table below. It can be seen that the rollers formed of ionic liquids were more stable with respect to time and temperature.

The print properties of the rollers were substantially the same.

| Ionic Compound | | (ii) | (iii) | (iv) |
|---|---|---|---|---|
| (2.44 mmol per | (i) Li | EMI | TBMA | TBMA |
| 100 g resin (phr) | TFSI | TFSI | TFSI | TFSI |
| Initial Resistance | 101.1 | 143.6 | 268.7 | 135.7 |
| (kΩ) | | | | |
| Resistance | 17.8% | 5.9% | 7.7% | 4.8% |
| increase after | | | | |
| 20,000 print | | | | |
| impressions | | | | |
| ρ(20% RH)/ρ(80% | 5.1 | 3.3 | 3.3 | 2.8 |
| RH | | | | |

RH = relative humidity
ρ = resistance

### EXAMPLE 7

In this Example, polyurethane compositions containing LiTFSI, EMI TFSI, TBMA TFSI and LiClO₄ were prepared and cast onto metal strips formed of aluminium metal.

The polyurethane coated strips were stored for 3 weeks at 60 degrees C. and 75% relative humidity. The metal strips were then inspected for corrosion.

| | LiTFSI | | | |
|---|---|---|---|---|
| | 3.48 mmol per | | | |
| | 100 g of resin | EMI TFSI | TBMA TFSI | LiClO₄ |
| | (phr) | 3.48 mmol phr | 6.97 mmol phr | 3.48 mmol phr |
| Al | Severe reversion | Slight | Slight | Severe reversion |
| | spots (due to | corrosion | corrosion | spots (due to |
| | corrosion, | | | corrosion, |
| | gelation and | | | gelation and |
| | bubble | | | bubble |
| | formation) | | | formation) |

### EXAMPLE 8

Polyurethane compositions E were prepared using the components and amounts shown in the table below.

| Material | Weight (g) |
|---|---|
| Polymeric isocyanates based on diphenyl | 14.03 |
| methane diisocyanate (Mondur ® MR light | |
| supplied by Covestro ®) | |
| Polycaprolactone polyol, Cape ® 2010A | 100 |
| (supplied by Perstorpe) | |
| 1, 4 Diazabicyclo [2.2.2] octane solution | 0.02 |
| (catalyst) | |
| Ionic Compound (i.e. Lithium | 6.97 mmol/100 g resin |
| bis(trifluoromethane)sulfonimide (LiTFSI), 1- | |
| ethyl-3-methyl imidazolium (EMI), 1-hexyl-3- | |
| methylimidazolium (HMI) or | |
| Tributylmethylamine | |
| bis(trifluoromethane)sulfonimide (TBMA | |
| TFSI)) | |

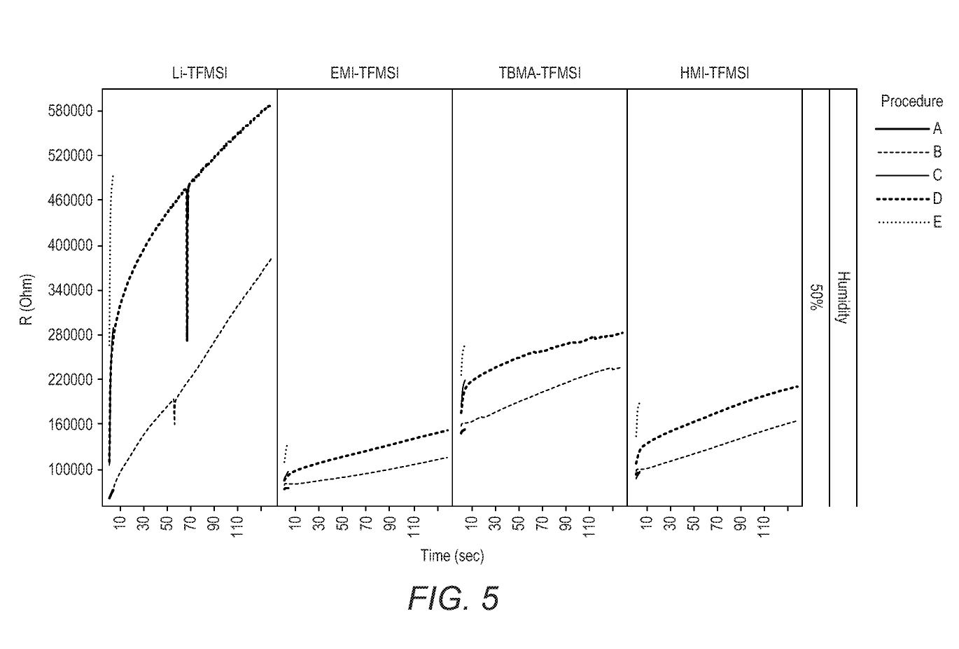

The polyurethane compositions E were cast into identical discs of a specified thickness. The samples were cured at 100 degrees C. for 3 hours and then conditioned at 50% relative humidity (RH). The samples were stored for a month and then subjected to a stress sequence A, B, C, D and E, whereby 100V (DC) was applied across each sample to subject it to an electric field of 5×10⁴ V/m for 3 seconds (step A), 2 minutes (step B), 3 seconds (step C), 2 minutes (step D) and then 3 seconds (step E). The resistance of each sample was determined and monitored over the duration of each stage. The results are shown in FIG. 5. It can be seen that the samples prepared using EMI TFSI, HMI TFSI and TBMA TFSI exhibited smaller increases in resistance than the polyurethane compositions prepared using Li TFSI when subjected to an electric field for an extended period of time.

1. An electroconductive roller for an electrophotographic printer, said roller comprising a polyurethane composition containing a polyurethane and an ionic liquid, wherein the cation of the ionic liquid is an organic cation, and wherein the polyurethane composition has a specific resistivity of 1×10⁵ Ω·cm to 1×10⁸ Ω·cm.

2. A roller as claimed in claim 1, wherein the polyurethane is formed from a polyol containing a polyether functional group or a polycaprolactone polyol.

3. A roller as claimed in claim 2, wherein polyol is a polyester polyol containing a polyether functional group formed from at least one of ethylene glycol, di(ethylene glycol), tri(ethylene glycol), tetra(ethylene glycol), poly(diethylene glycol), poly(ethylene oxide) or mixtures thereof.

4. A roller as claimed in claim 2, wherein the polyurethane is formed from the reaction between the polyol and an aromatic isocyanate.

5. A roller as claimed in claim 1, wherein the ionic liquid comprises a cation selected from an imidazolium cation, a piperidinium cation, a pyridinium and a quaternary ammonium cation of the formula NR₁R₂R₃R₄⁺, wherein each of R₁, R₂, R₃ and R₄ are independently selected from an alkyl, cycloalkyl or aryl group.

6. A roller as claimed in claim 5, wherein the cation is tributylmethyl ammonium (TBMA), trimethylbutyl ammonium (BTMA), 1-ethyl-3-methyl imidazolium (EMI), 1-hexyl-3-methylimidazolium (HMI), 1-decyl-3-methylimidazolium (DMI), 1-butyl-3-methylimidazolium (BMI), 1-butyl-3-methylpyridinium (BMPy) and cyclohexyltrimethyl ammonium (CHTMA).

7. A roller as claimed in claim 1, wherein the anion of the ionic liquid is bis(trifluoromethane)sulfonimide (TFSI).

8. A roller as claimed in claim 1, wherein the ionic liquid is present in an amount of 0.5 to 20 weight % of the total weight of the polyurethane composition.

9. A roller as claimed in claim 1, wherein the polyurethane composition is disposed around and is in contact with a central metal shaft.

10. A roller as claimed in claim 1, wherein the polyurethane composition contains 0 to less than 0.5 weight % of a lithium metal salt.

11. A roller as claimed in claim 1, wherein the polyurethane composition has a specific resistivity of 5×10⁵ Ω·cm to 1×10⁷ Ω·cm.

12. A liquid electrophotographic printer comprising an electroconductive roller comprising a polyurethane composition containing a polyurethane and an ionic liquid, wherein the cation of the ionic liquid is an organic cation, and wherein the polyurethane composition has a specific resistivity of 1×10⁵ Ω·cm to 1×10⁸ Ω·cm.

13. A printer as claimed in claim 12, which further comprises a secondary roller that co-operates with the electroconductive roller.

14. A printer as claimed in claim 13, wherein the secondary roller is formed of metal.

15. A method of developing an ink, said method comprising:
using an electric field to apply a liquid electrophotographic ink comprising an organic solvent to a surface of a developer roller,
removing organic solvent from a surface of a developer roller using a secondary roller, and
transferring the remaining electrophotographic ink from the surface of the developer roller to a photo-imaging plate to create an image,
wherein the developer roller comprises a polyurethane composition containing a polyurethane and an ionic liquid, wherein the cation of the ionic liquid is an organic cation, and wherein the polyurethane composition has a specific resistivity of 1×10⁵ Ω·cm to 1×10⁸ Ω·cm.
